(19) United States
(12) Patent Application Publication
(10) Pub. No.: US 2023/0298020 A1
(43) Pub. Date: Sep. 21, 2023

(54) METHODS AND APPARATUSES FOR ACCESS CONTROL OF PRIVATE KEY INFORMATION IN UNIFORM RESOURCE LOCATORS (URLS) USING FRAGMENTS AND KEY DERIVATION FUNCTIONS

(71) Applicant: TipLink Corp., New York, NY (US)

(72) Inventors: Ian KROTINSKY, New York, NY (US); Aashiq DHEERAJ, New York, NY (US)

(21) Appl. No.: 18/122,011

(22) Filed: Mar. 15, 2023

Related U.S. Application Data
(60) Provisional application No. 63/269,395, filed on Mar. 15, 2022.

(51) Int. Cl. G06Q 20/40; H04L 9/08; G06Q 20/36

(52) U.S. Cl. CPC G06Q 20/401; H04L 9/0861; G06Q 20/36

(57) ABSTRACT

In an embodiment, a method includes receiving, via a processor of a first compute device, a request to send a digital asset associated with a digital account of a user. The method further includes generating, via the processor and in response to receiving the request, a URL that includes (1) a base URL and (2) a representation of a private key associated with the digital asset and the digital account of the user. The method further includes causing, via the processor, the URL to be received by a second compute device that is configured to have access to the digital asset in response to accessing the URL.

### CROSS REFERENCE TO PRIORITY APPLICATION

This application claims priority to and the benefit of U.S. Provisional Application No. 63/269,395, filed Mar. 15, 2022 and title “URL BASED DIGITAL ASSET OWNERSHIP”, the content of which is incorporated herein by reference in its entirety.

### FIELD

One or more embodiments are related to methods and apparatuses for access control of private key information in uniform resource locations (URLs) using fragments and key derivation functions.

### BACKGROUND

Owning and transferring digital assets over the internet can be complex. Some known processes can sometimes require would-be users to be technically proficient. For example, they may have to download software or make accounts at potentially untrustworthy intermediaries. In addition, some known processes for transferring digital assets requires the recipient to have compatible software and be willing to provide information about themselves, interfering with their privacy.

### SUMMARY

In an embodiment, a method includes receiving, via a processor of a first compute device, a request to send a digital asset associated with a digital account of a user. The method further includes generating, via the processor and in response to receiving the request, a URL that includes (1) a base URL and (2) a representation of a private key associated with the digital asset and the digital account of the user. The method further includes causing, via the processor, the URL to be received by a second compute device that is configured to have access to the digital asset in response to accessing the URL.

In an embodiment, an apparatus includes a memory and a processor operatively coupled to the memory. The processor is configured to receive a URL that (1) includes a base URL and a representation of a private key associated with a first user, and (2) is associated with a digital asset of the first user. The processor is further configured to display, in response to receiving an indication that a second user has selected the URL, a webpage associated with the URL. The processor is further configured to cause, in response to receiving an indication that the second user has requested to access the digital asset via the webpage, the digital asset to be transferred from a digital account associated with the first user to a digital account associated with the second user.

In an embodiment, a non-transitory medium stores code representing instructions to be executed by one or more processors. The instructions comprise code to cause the one or more processors to send, from a first compute device associated with a first digital account of a first user and to a second compute device associated with a second digital account of a second user, a first URL that includes (1) a first base URL and (2) a representation of a private key associated with the first digital account and a first digital asset, to cause the first digital asset to be transferred from the first digital account to the second digital account in response to the second compute device accessing a webpage associated with the first URL. The instructions further comprise code to cause the one or more processors to receive, at the first compute device and from a third compute device associated with a third digital account of a third user, a second URL that includes (1) a second base URL and (2) a representation of a private key associated with the third digital account and a second digital asset. The instructions further comprise code to cause the one or more processors to access a webpage associated with the second URL. The instructions further comprise code to cause the one or more processors to receive, in response to accessing the webpage associated with the second URL, a representation of the second digital asset in the first digital account.

### BRIEF DESCRIPTION OF THE DRAWINGS

FIG. 1 shows a block diagram of a system for sending a digital asset from a sending compute device to a receiving compute device via a URL, according to an embodiment.

FIG. 2 shows a technology stack structure, according to an embodiment.

FIG. 3 shows a block diagram illustrating a sequence of steps for creating a URL, according to an embodiment.

FIG. 4 shows a block diagram illustrating a sequence of steps for accessing a digital asset after a digital wallet has been created, according to an embodiment.

FIG. 5 shows a technology stack structure that uses a fragment, according to an embodiment.

FIG. 6 shows a block diagram illustrating a sequence of steps for creating a URL, according to an embodiment.

FIG. 7 shows a block diagram illustrating a sequence of steps for accessing a digital asset after a digital wallet has been created, according to an embodiment.

FIG. 8 shows a technology stack structure that uses a fragment and shortened private key, according to an embodiment.

FIG. 9 shows a block diagram illustrating a sequence of steps for creating a URL, according to an embodiment.

FIG. 10 shows a block diagram illustrating a sequence of steps for accessing a digital asset after a digital wallet has been created, according to an embodiment.

FIG. 11 shows a flowchart of a method to cause a digital asset to be sent from a first compute device to a second compute device, according to an embodiment.

FIG. 12 shows a flowchart of a method to receive a digital asset via a URL, according to an embodiment.

FIG. 13 shows a flowchart of a method to send and receive digital assets via URLs, according to an embodiment.

FIGS. 14A-14D shows example screenshots after receiving a URL, according to an embodiment.

### DETAILED DESCRIPTION

Some implementations are related to uniform resource locator (URL)-based digital asset being sent and received. In some implementations, the URL acts as a digital asset wallet. If the compute device of a sender (i.e., sending compute device) puts the relevant information to access a digital asset into the URL, the compute device of a recipient (i.e., receiving compute device) can accept that digital asset without having to download any app, browser extension, and/or the like. Rather, the digital asset can be accepted by accessing a webpage associated with the URL and hosted by a server compute device.

Known technology includes for example cryptocurrency wallets that are implemented by either browser extensions or apps that store a cryptographic seed in the application. A difference between these known technologies and at least some of the embodiments presented herein is that these known technologies do not support link-based payments and/or use an application to view and use digital assets.

Other known technologies do have link-based cryptocurrency payments. These known technologies, however, are different from at least some of the embodiments presented herein in that the link only prompts the compute device of a user to download an app, which then allows the compute device of the user to access the cryptocurrency. In contrast, in at least some of the embodiments presented herein, the link actually contains the information to retrieve the private key. In some implementations, the link is the wallet.

Yet another known technology includes sending cryptocurrency with a link that is a smart contract link, which when activated results in the cryptocurrency going directly into a previously-established cryptocurrency wallet. Unlike at least some of the embodiments described herein, however, the link in such technologies is just a temporary state to move onto another application.

Some other known technologies use the fragment part of a URL to securely send text or files to other compute devices, but those known technologies have no relation to anything with digital assets or interacting with cryptocurrency/the blockchain. It does not, for example, generate a smart private key that can be used as a wallet.

In some implementations, a “key pair” can be, for example, a combination of a cryptographic public key and a longer cryptographic private key, which enables custody of digital assets. Different cryptocurrencies can have different conventions for the structure of these key pairs. For example, a public key and private key making up a keypair associated with a cryptocurrency can be defined with respect to a point on an elliptic curve. Different elliptic curves can have different key lengths. For example, the ed25519 curve is used in Solana, and has a private key length of 32 bytes. A public/private keypair on Solana would not be valid for Bitcoin, however, which uses the secp256k1 curve.

In some implementations, a “uniform resource locator” (i.e., URL) can be, for example, a reference to a web resource that specifies the web resource's location on a computer network and a mechanism for retrieving the web resource. In some implementations, URLs are a subset of the more general class of Uniform Resource Identifiers (URIs), so they can conform to the same schema specified in, for example, RFC 3986:

URL=scheme “:”[“//” authority]path[“?” query][“#” fragment]

authority=[userinfo “@”]host[“:” port]

Additional details related to RFC 3986 can be found at Berners-Lee, T., Fielding, R. T., &amp; Masinter, L. M. (2005, January 25). RFC FT-fielding-uri-rfc2396bis: Uniform resource identifier (URI): Generic syntax. IETF Datatracker. Retrieved Mar. 9, 2023, from https://datatracker.ietf.org/doc/html/rfc3986#section-3.1, the contents of which are incorporated by reference in its entirety herein.

In some implementations, a “fragment” can refer to, for example the optional last part of a URL that includes (e.g., begins with) and/or is after (e.g., directly after) an anchor (e.g., the ‘#’) symbol. For example, in some instances, if a full URL is Link.com/#ABC, the anchor could be ‘#’ and the fragment could be ‘ABC.’ In some instances, a fragment is used only within the context of a browser of a client-side device(s), and does not get sent to, for example, the server side.

In some implementations, a “digital asset” can refer to, for example, a rivalrous (and therefore potentially scarce) asset whose canonical representation is electronic. In some implementations, a digital asset described herein refers to, for example, an asset represented by distributed ledger technology, such as blockchains. In some implementations, a digital asset can additionally and/or alternatively refer to in-game assets whose integrity is ensured by a centralized entity (e.g., a gaming company).

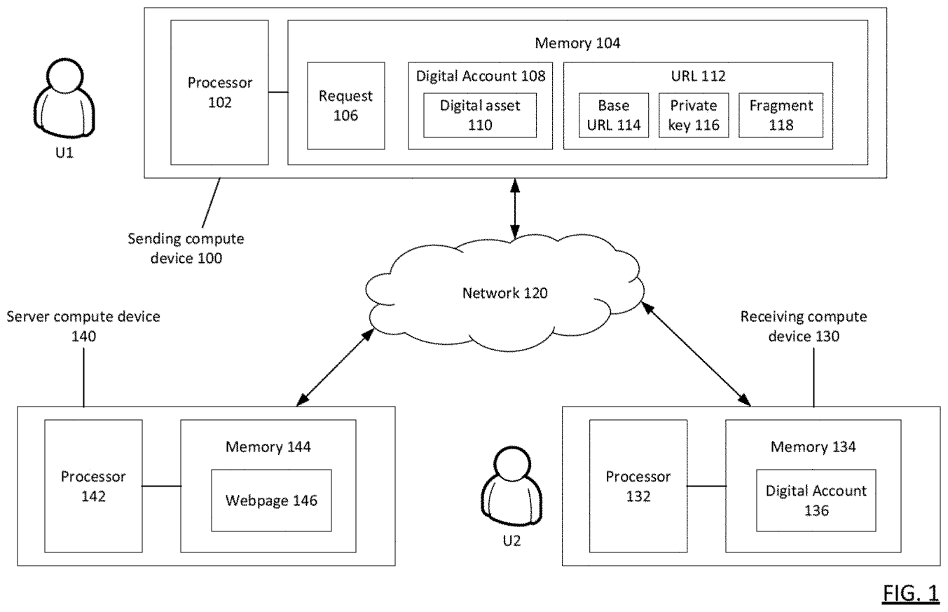

FIG. 1 shows a block diagram of a system for sending a digital asset from a sending compute device to a receiving compute device via a URL, according to an embodiment. FIG. 1 includes a sending compute device 100 (also referred to herein as a first or second compute device), a receiving compute device 130 (also referred to herein as a first or second compute device), and a server compute device 140 (also referred to herein as the server side or server side compute device), each communicably coupled to one another via network 120. In some implementations, sending compute device 100 can be used to cause a digital asset to be transferred from a digital account associated with sending compute device 100 to a digital account associated with receiving compute device 130 via, for example, a webpage hosted by server compute device 140.

The network 120 can be any suitable communications network for transferring data, operating over public and/or private networks. For example, the network 120 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the network 120 can be a wireless network such as, for example, a Wi-Fi or wireless local area network (“WLAN”), a wireless wide area network (“WWAN”), and/or a cellular network. In other instances, the network 120 can be a wired network such as, for example, an Ethernet network, a digital subscription line (“DSL”) network, a broadband network, and/or a fiber-optic network. In some instances, the network 120 can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)). The communications sent via the network 120 can be encrypted or unencrypted. In some instances, the network 120 can include multiple networks or subnetworks operatively coupled to one another by, for example, network bridges, routers, switches, gateways and/or the like.

Sending compute device 100 includes a processor 102 operatively coupled to a memory 104 (e.g., via a system bus). Sending compute device 100 can be any type of compute device, such as desktop, laptop, tablet, smartphone, server, and/or the like. In some implementations, sending compute device 100 is associated with (e.g., owned by, accessible by, being used by, and/or the like) a user U1.

Processor 102 can be, for example, a hardware-based integrated circuit (IC) or any other suitable processing device configured to run and/or execute a set of instructions or code. For example, processor 102 can be a general-purpose processors, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, processor 102 can be configured to run any of the methods and/or portions of methods discussed herein.

Memory 104 can be, for example, a random-access memory (RAM), a memory buffer, a hard drive, a read-only memory (ROM), an erasable programmable read-only memory (EPROM), and/or the like. Memory 104 can be configured to store any data used by the processors to perform the techniques (methods, processes, etc.) discussed herein. In some instances, memory 104 can store, for example, one or more software programs and/or code that can include instructions to cause processor 102 to perform one or more processes, functions, and/or the like. In some implementations, memory 104 can include extendible storage units that can be added and used incrementally. In some implementations, memory 104 can be a portable memory (for example, a flash drive, a portable hard disk, and/or the like) that can be operatively coupled to processor 102. In some instances, memory 104 can be remotely operatively coupled with a compute device (e.g., not shown in FIG. 1).

Server compute device 140 includes a processor 142 operatively coupled to a memory 144 (e.g., via a system bus). Server compute device 140 can be any type of compute device, such as desktop, laptop, tablet, smartphone, server, and/or the like. In some implementations, server compute device 140 is associated with (e.g., owned by, accessible by, being used by, and/or the like) a third party different than users U1 and U2.

Processor 142 can be, for example, a hardware-based integrated circuit (IC) or any other suitable processing device configured to run and/or execute a set of instructions or code. For example, processor 142 can be a general-purpose processors, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, processor 142 can be configured to run any of the methods and/or portions of methods discussed herein.

Memory 144 can be, for example, a random-access memory (RAM), a memory buffer, a hard drive, a read-only memory (ROM), an erasable programmable read-only memory (EPROM), and/or the like. Memory 144 can be configured to store any data used by the processors to perform the techniques (methods, processes, etc.) discussed herein. In some instances, memory 144 can store, for example, one or more software programs and/or code that can include instructions to cause processor 142 to perform one or more processes, functions, and/or the like. In some implementations, memory 144 can include extendible storage units that can be added and used incrementally. In some implementations, memory 144 can be a portable memory (for example, a flash drive, a portable hard disk, and/or the like) that can be operatively coupled to processor 142. In some instances, memory 144 can be remotely operatively coupled with a compute device (e.g., not shown in FIG. 1).

Memory 144 can include (e.g., store) a representation of webpage 146. Webpage 146 can be, for example, a website associated with URL 112. For example, if user U2 selects URL 112 using receiving compute device 100, webpage 146 can be displayed on receiving compute device 130 via server compute device 140 so that user U2 can navigate webpage 146 using receiving compute device 130 and redeem digital asset 110.

Memory 104 of sending compute device 100 can include (e.g., store) a representation of a digital account 108. The digital account 108 can be associated with (e.g., in the name of, created by, owned by, accessible by, exclusively accessible by, and/or the like) user U1. In some implementations, the digital account 108 is a digital wallet. In some implementations, digital account 108 is linked to a crypto wallet, bank account, and/or the like. The digital account 108 can include/have a representation of digital asset 110. The digital asset 110 could be, for example, a representation of an amount of money, a representation of a cryptocurrency, a representation of a stock, and/or the like. Note that, in some implementations, the asset that is associated with the digital asset 110 does not have to be digital (though in other implementations it is). For example, the non-digital asset could be cash and the digital asset representing the cash could be, for example, a balance in a bank account representing that cash and accessible via a digital device.

Memory 104 of sending compute device 100 can also include (e.g., store) a representation of a request 106. In some implementations, request 106 represents a request for the generation of a URL 112 to send the digital asset 110. For example, request 106 can be a request to generate a URL 112 to send $1 of Bitcoin, $10,000 of Solana, a non-fungible token (NFT), a virtual good, and/or the like. In some implementations, request 106 also includes an indication of a recipient for the digital asset 110 (e.g., user U2). In some implementations, request 106 does not include an indication of a recipient for the digital asset 110; rather, URL 112 is generated and user U1 can choose who to share the URL 112 with later.

Request 106 can be generated based on input from user U1 at sending compute device 100 and/or server compute device 140. For example, user U1 may interface with a native application and/or website (e.g., webpage 146) displayed on sending compute device 100 (e.g., and hosted by server compute device 140) to request the generation of a URL 112. Requesting generation of URL 112 can include indicating that digital asset 110 is to be sent. For example, if digital account 108 holds $100 in Bitcoin, $150 in Ether, and $200 in Solana, user U1 may indicate that digital asset 110 is to be $50 in Bitcoin.

Memory 104 of sending compute device 100 can also include (e.g., store) a representation of URL 112. In some implementations, URL 112 can be generated in response to (e.g., automatically and without requiring human input) request 106. In some implementations, URL 112 is generated after receiving request 106 and confirming that digital asset 110 is included in digital account 108. In some implementations, URL 112 is associated with webpage 146. By selecting URL 112, webpage 146 can be accessed. In some implementations, request 106 is sent to server compute device 140, server compute device 140 generates URL 112, and sends URL 112 to sending compute device 100 for sending to receiving compute device 130.

URL 112 can include base URL 114 and private key 116. The base URL 114 is the root of URL 112. Sequentially, base URL 114 can be in front of (sequentially before) private key 116. In some implementations, the private key 116 is associated with request 106 and not other requests to transfer a digital asset different than digital asset 110. Said similarly, private key 116 is unique to the transaction of digital asset 110 from digital account 108 to digital account 136 in response to request 106. For other transfers of digital assets from a first digital account (e.g., digital account 108, digital account 136, and/or a digital account not shown in FIG. 1) to a second digital account (e.g., digital account 108, digital account 136, and/or a digital account not shown in FIG. 1), a different private key can be used. In some implementations, private key 116 is a private key associated with (e.g., identifying, used to access, etc.) digital account 108 and/or digital asset 110. In some implementations, private key 116 is a shortened version of the private key associated with (e.g., identifying, used to access, etc.) digital account 108 and/or digital asset 110. Where private key 116 is a shortened version, a key derivation function can be used to shorten the private key associated with digital account 108 and/or digital asset 110 to generate private key 116. In some implementations, the key derivation function is compute intensive above a predetermined threshold and/or memory intensive above a predetermined threshold. Examples of key derivation functions include scrypt, bcrypt, Argon2, password-based key derivation key function 1 (PBKDF1), password-base key derivation function 2 (PBKDF2), and/or the like.

In some implementations, URL 112 also includes fragment 118. Fragment 118 can be, for example, an internal page reference. In some implementations, fragment 118 is the characters sequentially after an anchor (e.g., #). Where fragment 118 is used, the sequence of URL 112 can be base URL 114, an anchor, and fragment 118. In some implementations, the fragment 118 is the same as private key 116. In some implementations, fragment 118 is a shortened version of private key 116 (where a key derivation function can be used to obtain the private key 116 from the shortened version of the private key 116).

A representation of URL 112 can be sent from sending compute device 100 to receiving compute device 130 (e.g., via network 120). In some implementations, the URL 112 can go through server compute device 140. For example, URL 112 can be first passed from sending compute device 100 to server compute device 140 for inspection and/or modification, and the server compute device 140 can send URL 112 to receiving compute device 130 thereafter. In some implementations, the URL is sent from sending compute device 100 to receiving compute device 130 without going through server compute device 140.

Receiving compute device 130 includes a processor 132 operatively coupled to a memory 134 (e.g., via a system bus). Receiving compute device 130 can be any type of compute device, such as desktop, laptop, tablet, smartphone, server, and/or the like. In some implementation, receiving compute device 130 is associated with (e.g., owned by, accessible by, being used by, and/or the like) a user U2.

Processor 132 can be, for example, a hardware-based integrated circuit (IC) or any other suitable processing device configured to run and/or execute a set of instructions or code. For example, processor 132 can be a general-purpose processors, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, processor 132 can be configured to run any of the methods and/or portions of methods discussed herein.

Memory 134 can be, for example, a random-access memory (RAM), a memory buffer, a hard drive, a read-only memory (ROM), an erasable programmable read-only memory (EPROM), and/or the like. The memories can be configured to store any data used by the processors to perform the techniques (methods, processes, etc.) discussed herein. In some instances, memory 134 can store, for example, one or more software programs and/or code that can include instructions to cause processor 132 to perform one or more processes, functions, and/or the like. In some implementations, memory 134 can include extendible storage units that can be added and used incrementally. In some implementations, memory 104 can be a portable memory (for example, a flash drive, a portable hard disk, and/or the like) that can be operatively coupled to processor 132. In some instances, memory 134 can be remotely operatively coupled with a compute device (e.g., not shown in FIG. 1).

Memory 134 can include (e.g., store) a representation of a digital account 136. The digital account 136 can be associated with (e.g., in the name of, created by, owned by, accessible by, exclusively accessible by, and/or the like) user U2. In some implementations, the digital account 136 is a digital wallet. In some implementations, digital account 136 is represented using (e.g., linked to) a crypto wallet, bank account, and/or the like.

Receiving compute device 130 can receive URL 112 via any communication format, technique, process, means, etc. For example, receiving compute device 130 can receive URL 112 via an email, a text message, a direct message, a chat message, a visual code, a QR code, and/or the like. As another example, user U1 could tell URL 112 to user U2 112 verbally, on paper, and/or the like, so that user U2 can enter the URL 112 on receiving compute device 130 to access webpage 146. URL 112 can be received before digital account 136 has been created, or can be received after digital account 136 has been created.

In response to receiving URL 112, webpage 146 associated with URL 112 can be accessed and displayed on receiving compute device 130 (e.g., in response to user U2 selecting URL 112, automatically without human intervention, and/or the like). In some implementations, URL 112 is an address, which can be used by, for example, a browser to access the web site file(s) (e.g., webpage 146) stored at server compute device 140 and identified by the address of the URL 112. The webpage can then be used to redeem digital asset 110. For example, user U2 can provide a public key associated with digital account 136 via the webpage to transfer digital asset 110 to digital account 136. As another example, user U2 can connect to their digital account 136 (e.g., using a username and password) via the webpage to transfer digital asset 110 to digital account 136.

After digital asset 110 has been redeemed, digital asset 110 can be removed/withdrawn from digital account 108 and added/deposited to digital account 136. Thereafter, digital asset 110 (or a portion of digital asset 110) can remain in digital account 136, be transferred to a different account, and/or the like.

Although FIG. 1 only shows three compute devices, it can be appreciated that more or less compute devices can be used to complete some of the aforementioned implementations. For example, digital asset 110 may be on a digital asset database, such as distributed network of computers (e.g., distributed ledger, blockchain, etc.). Transacting the transfer of digital asset 110 from digital account 108 to digital account 136 can be recorded on the distributed network.

Although FIG. 1 shows a single server compute device 140, it can be appreciated that any number of compute devices can be used as a server. For example, in some implementations, webpage 146 is hosted on a content delivery network (CDN), such as Amazon® S3 buckets or InterPlanetary File System (IPFS), and/or the like.

In some implementations, any of the steps performed and/or software objects generated at sending compute device 100 and/or receiving compute device 130 can additionally and/or alternatively be performed at any other compute device. For example, the URL 112 can be generated by a server compute device not shown in FIG. 1.

In some implementations, any number of URLs can be generated. For example, sending compute device 100 can generate a first URL to send $100 worth of Bitcoin to a first compute device, a second URL to send $50 worth of Ether to a second compute device, etc.

Note that sending compute device 100 is not limited to sending URL 112. Like receiving compute device 130, sending compute device 100 can also receive URLs to redeem digital assets. Similarly, receiving compute device 130 is not limited to receiving URL 112. Like sending compute device 100, receiving compute device 130 can also send URLs to share digital assets.

Implementation 1: Full URL Wallet with Server Side Integration

An implementation includes using a private key (e.g., private key 116), such as the following:

43MijUWU2Vno7WehGTEjubMVfYVM9BFzKurnmLYMg87HBPpPqgmGYrCf6yhYksvp3 W ZK8C sFZ9Ppo2Tgy54kaqzz
and appending it to a base URL (e.g., base URL 114), such as Link.com, like so:
Link.com/43MijUWU2Vno7WehGTEjubMVfYVM9BFzKurnmLYMg87HBPpPqgmGYrCf6yh Yksv p3WZK8CsFZ9Ppo2Tgy54kaqzz

In such a case, the private key can be both accessible/known by the client side compute device (e.g., sending compute device 100 and/or receiving compute device 130) via the URL, as well as by the server compute device (e.g., server side compute device 140) because that private key can be sent to server compute device 140. Every time a compute device calls a site, either the client side or the server side can provide the private key, which allows the compute device to access the digital asset (e.g., funds) that sit within their digital account (e.g., crypto wallet). In some implementations, the server compute device is a third party that controls a webpage(s) (e.g., webpage 146) and facilitates the transfer of a digital asset (e.g., digital asset 110) from a first digital account (e.g., digital account) 108 to a second digital account (e.g., digital account 136) after URL 112 has been sent from sending compute device 100 to receiving compute device 130 after user U2 has selected URL 112.

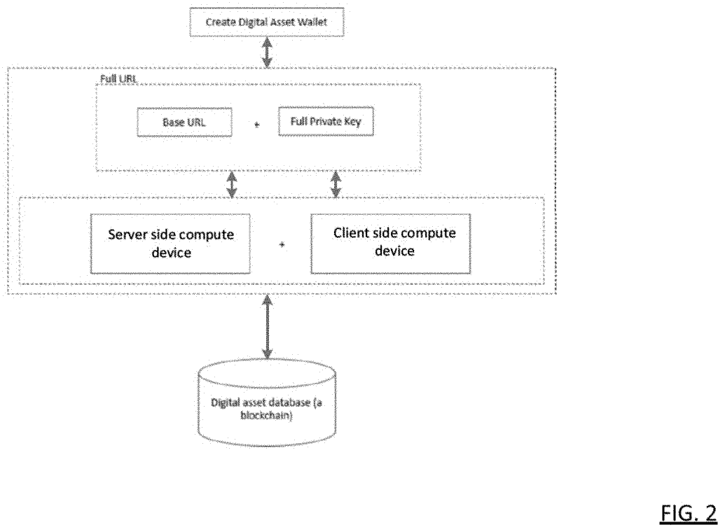

The technology stack structure of this database is shown in FIG. 2, according to an embodiment. In this example, both the server compute device and client compute device(s) interact with the full URL, including the full private key, to interact with the digital asset database (e.g., distributed ledger, blockchain, etc.).

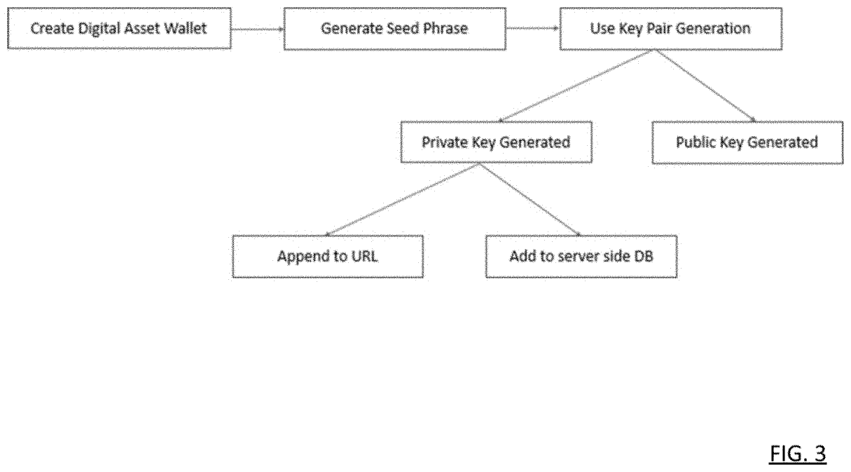

FIG. 3 shows a block diagram illustrating a sequence of steps for creating a URL, according to an embodiment. Here, a digital asset wallet (e.g., digital account 108) is first created—consisting of a seed phrase and a key pair that includes a public key and a private key (e.g., private key 116). The private key is appended to the base URL (e.g., base URL 114) to generate a full URL (e.g., URL 112), and the full URL is sent to the server-side compute device. In some implementations, the server-side compute device uses the private key to transfer the digital asset from the first digital account to the second digital account, and uses the base URL to identify where to send the site. The full URL can then be stored in the server side database (DB) to complete the wallet process.

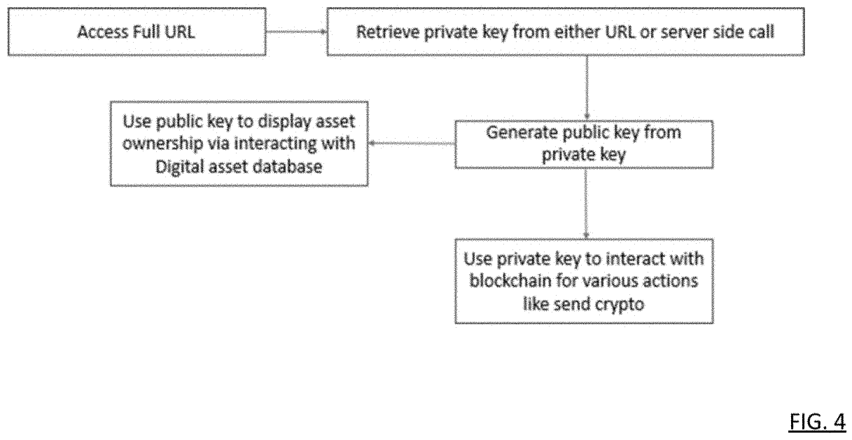

FIG. 4 shows a block diagram illustrating a sequence of steps for accessing a digital wallet (e.g., user account 108) that has already been created and owns some digital asset (e.g., digital asset 110) at the public address, according to an embodiment. Said differently, FIG. 4 shows a block diagram illustrating a sequence of steps for accessing a digital asset after a digital wallet has been created.

In the workflow shown in FIG. 4, the receiving compute device (e.g., receiving compute device 130) first accesses the full URL to retrieve the private key on either client or server side. For example, the receiving compute device can parse the full URL to retrieve the private key. As another example, the receiving compute device can send an application programming interface (API) call to the server side compute device to parse the private key and send the private key to receiving compute device. Then the receiving compute device can generate the public key from that private key. In some implementations, generating the public key from the private key can include extracting the seed from the private key, and using the seed to rederive the private key and the public key. In some implementations, the public key is publicly available (e.g., from sending compute device 100); once the public key is identified/retrieved by the receiving compute device, the public key can then be associated with the private key to define the key pair. With the public and private keys, the receiving compute device can display digital assets and/or interact with, for example, the blockchain for transactions using the private key.

Implementation 2: Full Key URL Wallet with Fragment Based Implementation

The difference between implementation 1 and implementation 2 is the additional use of anchors and URL fragments (e.g., fragment 118) in implementation 2.

If a private key is appended to the end of the base URL to generate a full URL, a message (e.g., email, text, etc.) that includes the full URL and the message can be sent to the server side compute device that hosts the webpage associated with that full URL—as well as any intermediaries, such as internet service providers. Some internet standards, such as internet standard RFC-1808, specify resource locators that are not considered part of the URL; the resource locations are separated by an anchor, sometimes represented as a hash (‘#’). The text after the anchor is the fragment; the fragment is interpreted by just client-side compute devices within the context of the browser, and is not considered when navigating to a webpage linked by the URL. While sometimes used as a reference to part of a webpage, in some implementations, URL fragments can be used for storing data (e.g., private data). Since only the client and client side compute device(s) have access to the private key, and the server compute device does not, the client and client side compute device(s) are provided with a measure of additional privacy and security. In addition, the server compute device not having access to the private key reduces the server compute device provider's potential liability since they don't have to secure this additional bit of private data (as they never receive the fragment).

To illustrate, using the same example from implementation 1, the link goes from:

Link.com/43MijUWU2Vno7WehGTEjubMVfYVM9BFzKurnmLYMg87HBPpPqgmGYrCf6yh Yksv p3WZK8CsFZ9Ppo2Tgy54kaqzz
as discussed at implementation 1 to:
Link.com/#43MijUWU2Vno7WehGTEjubMVfYVM9BFzKurnmLYMg87HBPpPqgmGYrCf6y hYks vp3WZK8CsFZ9Ppo2Tgy54kaqzz

The ‘#’ is the anchor, and the characters after the anchor act as/indicates the fragment. By using this “#” in the URL, which has not been used previously for crypto-based key storage, the private key is not actually part of the URL from the perspective of server-side compute device. Said differently, the server compute device side does not receive (or receives and uses but does not save) the fragment (which in this case is the private key). This means that, for example, if the server-side compute device is hacked or compromised in any way, funds will not be lost because the private keys are not stored on the server-side compute device at all. This also allows for serverless structures.

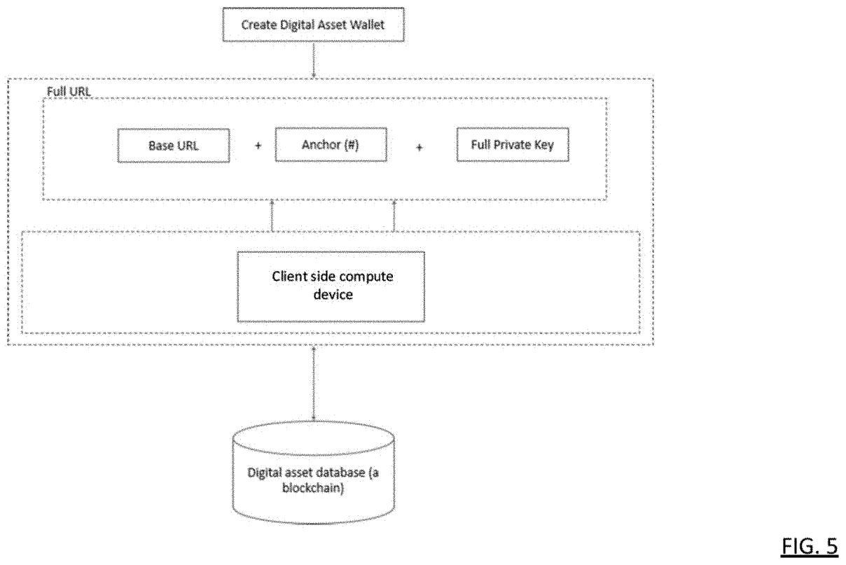

The technology stack structure of this database is shown in FIG. 5, according to an embodiment. The difference between FIG. 5 and FIG. 2 is that the full URL in FIG. 5 includes a fragment) while the full URL in FIG. 2 does not. In FIG. 5, only the client-side compute device(s) uses and/or takes actions based on with the full URL, including the full private key, to interact with the digital asset database (e.g., distributed ledger, blockchain, etc.). Implementation 2 may be desirable in situations where keeping information on the client compute device side is desirable. In one version of implementation 2, a webpage (e.g., webpage 146) can be retrieved (e.g., by sending compute device 100 and/or receiving compute device 130) from a compute device(s) (e.g., server compute device 140), similar to how a compute device would for example download an image. In some versions of the implementation, the webpage is hosted on a content delivery network (CDN), such as Amazon® S3 buckets, InterPlanetary File System (IPFS), and/or the like. After fetching the webpage, there is no need for further communication (e.g., by sending compute device 100 and/or receiving compute device 130) with any backend server (e.g., server compute device 140) to effect transactions of digital assets (e.g., digital asset 100).

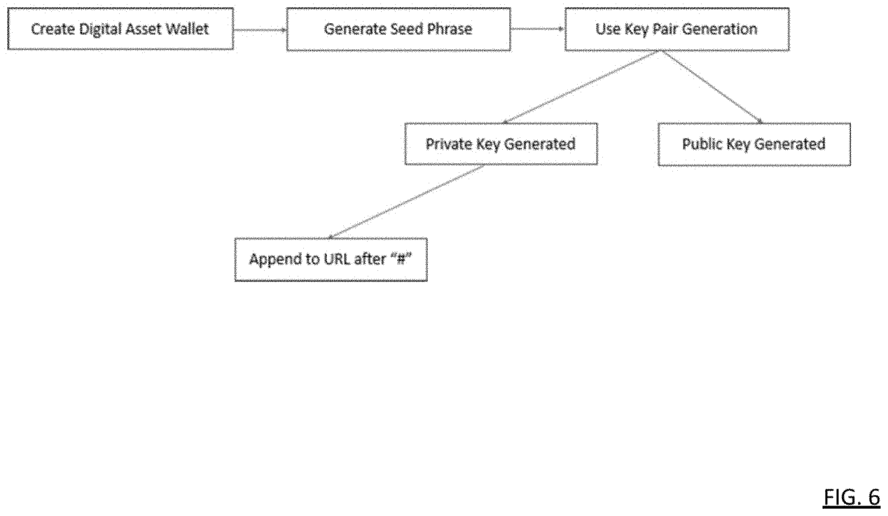

FIG. 6 shows a block diagram illustrating a sequence of steps for creating a URL, according to an embodiment. The sequence shown in FIG. 6 is similar to the sequence shown in FIG. 3 except for the usage of an anchor and fragment. The digital asset wallet creation process begins with generating the seed phrase, using that seed phrase to generate a key pair, and appending the private key at the end of the URL after the anchor (#). Unlike the sequence shown in FIG. 3, however, the sequence of FIG. 6 does not have to send the full URL to the server side.

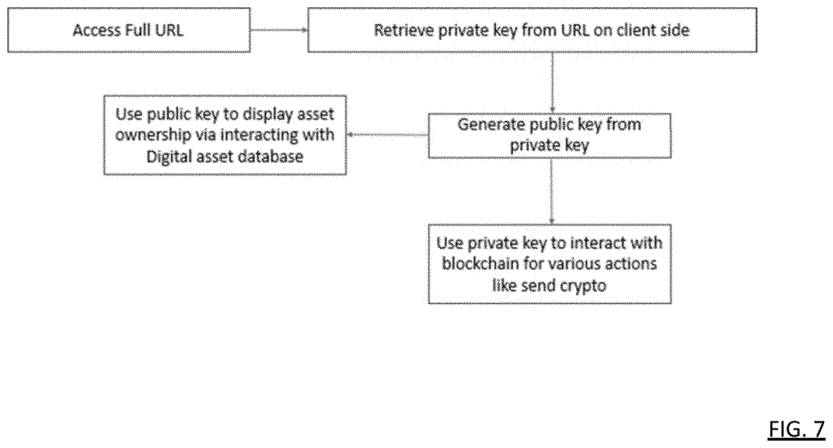

FIG. 7 shows a block diagram illustrating a sequence of steps for accessing a digital wallet (e.g., user account 108) that has already been created and owns some digital asset (e.g., digital asset 110) at the public address. Said differently, FIG. 7 shows a block diagram illustrating a sequence of steps for accessing a digital asset after a digital wallet has been created and after the full URL has been created.

This sequence shown in FIG. 7 is similar to the sequence shown in FIG. 4. The difference is that after URL access, the private key can be retrieved from the URL on the client side without the server side having access to the private key at FIG. 7. In the sequence shown in FIG. 4, however, an interaction can take place with the server side while constructing the full URL.

Implementation 3: Partial Key Using Key Derivation and Fragment

In implementation 2, the URL looks like the below:

Link.com/#43MijUWU2Vno7WehGTEjubMVfYVM9BFzKurnmLYMg87HBPpPqgmGYrCf6y hYks vp3WZK8CsFZ9Ppo2Tgy54kaqzz

It can sometimes be desirable to shorten the above URL. For example, shortening the above URL may save memory, be faster to send, and/or faster to receive. As another example, it is possible that a user assumes that the longer the URL, the more likely that link is untrustworthy; as such, the user may not click on the URL. Therefore, in implementation 3, key derivation can be used to shorten the URL from implementations 1 and/or 2 while also preserving the private key and maintaining cybersecurity.

For example, in implementation 3, the URL from implementation 2 can be shortened to:

Link.com/#ADfc343DFda2073

Note that in the shortened link, the fragment (“ADfc343DFda2073”) is different than the private key (‘43MijUWU2Vno7WehGTEjubMVfYVM9BFzKurnmLYMg87HBPpPqgmGYrCf6yhYks vp3WZK8CsFZ9Ppo2Tgy54kaqzz’). In some implementations, a key derivation function can use at least one of three parameters: bytes, desired length, and a salt. With these parameters, a longer length of characters can be derived from a shorter length. Additionally, not only can the key derivation function derive a longer length of characters from a shorter length of characters, the key derivation function can also use time and/or system resources to perform the derivation (depending on the key derivation function). The more resources used to perform the key derivation, the more security the application gains from brute force attacks. Thus, if an attacker wants to guess every possible combination, the attacker will use the key derivation function each time, which makes guessing increasingly computationally infeasible. On top of this, implementation 3 can use the key derivation function multiple times per URL (transaction) to increase the time and improve security further.

The randomly-generated salt can be used to protect the application from, for example, rainbow table attacks, where an attacker has precomputed the output of your key derivation function for many inputs. Different salts will give different results. In some implementations, a user-specific salt is used, which could be stored on the server-side compute device and/or offline. In some implementations, a fixed application-specific salt is used—essentially reducing the number of parameters in the key derivation function to two: a series of bytes and the desired length.

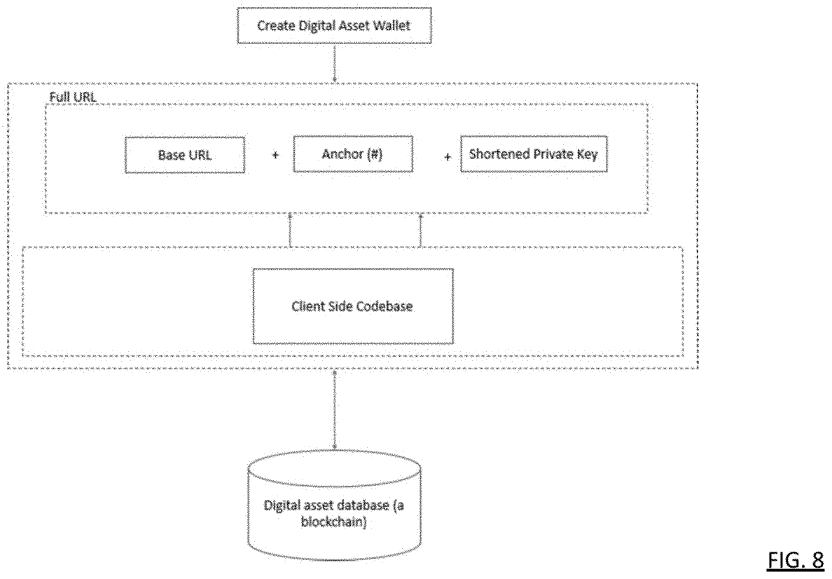

The technology stack structure of this database is shown in FIG. 8, according to an embodiment. The difference between FIG. 8 and FIG. 5 is that the full URL in FIG. 8 includes a shortened private key, while the full URL in FIG. 5 does not. As was the case in FIG. 5, however, only the client side compute device interacts with the full URL during the creation of the full URL.

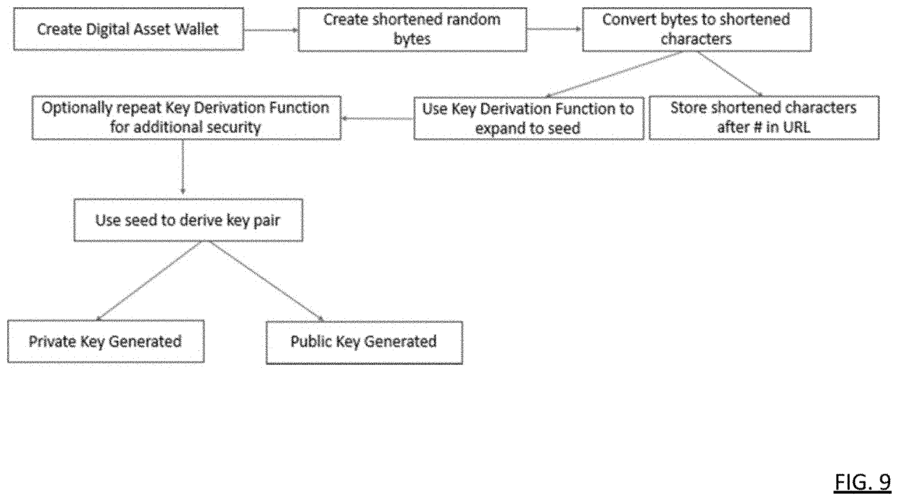

FIG. 9 shows a block diagram illustrating a sequence of steps for creating a URL, according to an embodiment. In FIG. 9, a digital asset wallet is generated, which also generates a buffer of random bytes. The length of the byte buffer is not as long as a normal private key or even a seed phrase. The bytes from the buffer of random bytes are then converted into characters. These characters are stored in the fragment in the URL (a much shorter URL than the original full private key). To generate the private key/public key, a key derivation function is used, which can expand the fragment to any arbitrary size, which in this case is the seed. If, for example, more security is desired, the key derivation function can be configured take at least a certain amount of compute time, and the key derivation function can be run multiple times for the derivation of the private key to take longer (since longer time is more secure). Once the seed is generated, the public/private key can be generated based on the seed.

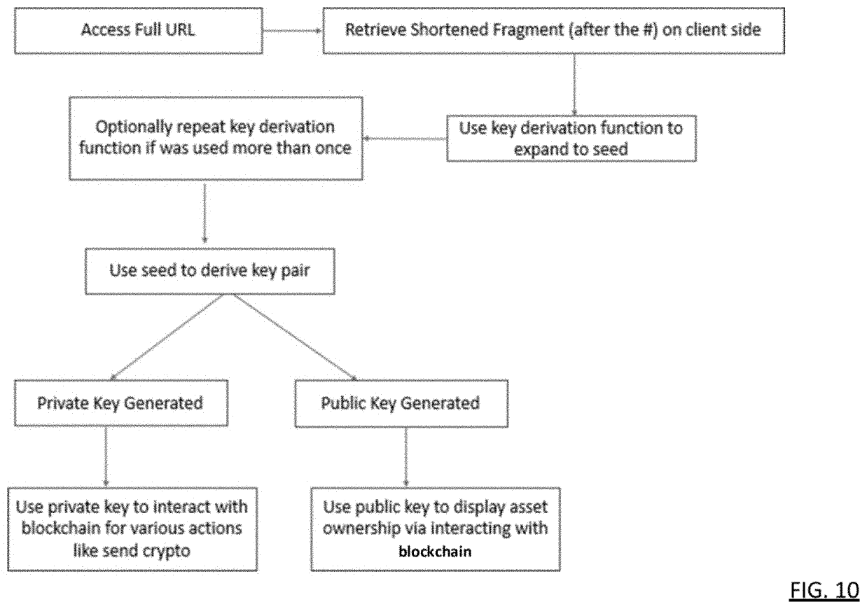

FIG. 10 shows a block diagram illustrating a sequence of steps for accessing a digital wallet (e.g., user account 108) that has already been created and owns some digital asset (e.g., digital asset 110) at the public address, according to an embodiment. Said differently, FIG. 10 shows a block diagram illustrating a sequence of steps for accessing a digital asset after a digital wallet has been created and after a message having the full URL has been received. A user first uses their compute device to access the full URL, and then retrieve the characters after the anchor (e.g., #). Then, the shortened characters after the anchor, the fragment, are passed through a key derivation function, which expands the key to a seed. In some implementations, that process may be repeated a number of times (e.g., the same number of times the key derivation function was used to generate the full URL) for additional security. Then, the seed can go through the process of generating a key pair and a user can now, using their compute device, view and interact with digital assets using the private/public key pair. For example, the private key can be used for “writing,” such as making a transaction of a digital asset between digital wallets, while the public key can be used for “reading,” such as viewing who owns a digital asset, checking account balances, and/or the like.

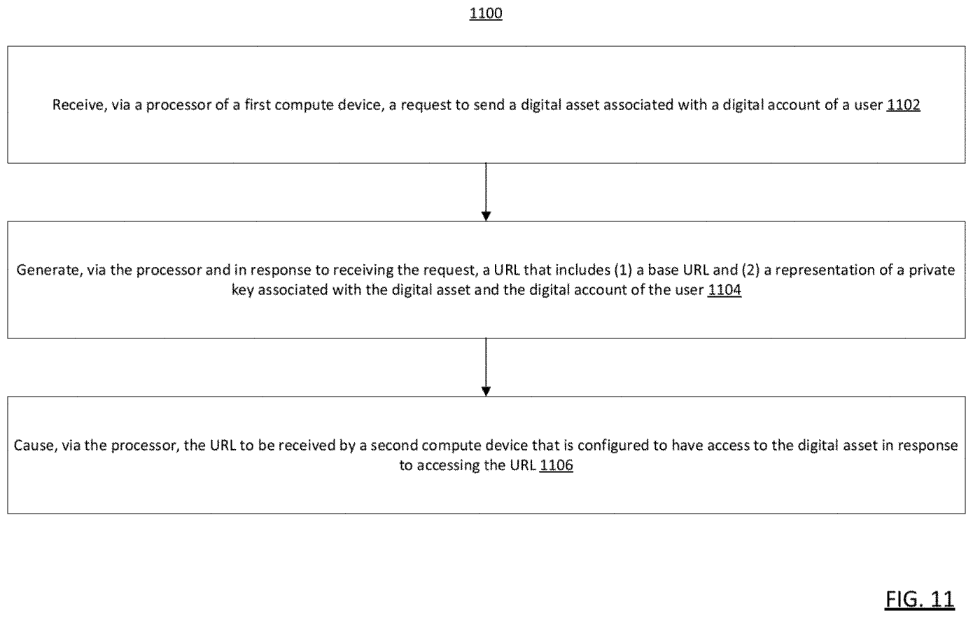

FIG. 11 shows a flowchart of a method 1100 to cause a digital asset to be sent from a first compute device to a second compute device, according to an embodiment. In some implementations, method 1100 can be performed by a processor (e.g., processor 102 and/or 132).

At 1102, a request (e.g., request 106) to send a digital asset (e.g., digital asset 110) associated with a digital account (e.g., digital account 108) of a user (e.g., user U1) is received via a processor (e.g., processor 102) of a first compute device (e.g., sending compute device 100). At 1104, a URL (e.g., URL 112) that includes (1) a base URL (e.g., base URL 114) and (2) a representation of a private key (e.g., private key 116) associated with the digital asset and the digital account of the user is generated via the processor and in response to receiving the request at 1102. In some implementations, 1104 occurs automatically (e.g., without human intervention) in response to completing 1102. At 1106, the URL is caused, via the processor, to be received by a second compute device (e.g., receiving compute device 130) that is configured to have access to the digital asset in response to accessing the URL. In some implementations, causing at 1106 can include sending an electronic signal to the second compute device and/or a third compute device (e.g., a server compute device). In some implementations, 1106 occurs automatically (e.g., without human intervention) in response to completing 1104.

In some implementations of method 1100, the URL further includes a URL fragment (e.g., fragment 118). In some implementations, the URL includes only the base URL, the URL fragment, and the representation of the private key. In some implementations, a sequence of the URL is the base URL followed by the URL fragment followed by the representation of the private key.

In some implementations of method 1100, a length of the representation of the private key is shorter than a length of the private key, and method 1100 further includes generating the representation of the private key using the private key and a key derivation function. In some implementations of method 1100, the key derivation function is at least one of compute intensive or memory intensive. In some implementations of method 1100, the request does not indicate a recipient of the digital asset. In some implementations of method 1100, the digital asset is a cryptocurrency, the digital account of the user is a digital asset wallet, and the request indicates an amount of cryptocurrency requested to be sent.

In some implementations of method 1100, the request is a first request, the digital asset is a first digital asset, the URL is a first URL, and method 1100 further includes receiving a second request to send a second digital asset. Some implementations of method 1100 further include generating a second URL that includes the base URL and the representation of the private key. Some implementations of method 1100 further include causing the second URL to be received by a third compute device different than the second compute device. The third compute device is configured to have access to the second digital asset in response to accessing the second URL. The second compute device is not configured to have access to the second digital asset in response to accessing the first URL.

Some implementations of method 1100 further include generating, via the processor and in response to receiving the request, a visual code (e.g., QR code) associated with the URL. The second compute device is configured to have access to the digital asset by accessing (e.g., taking a picture of) the URL via the visual code.

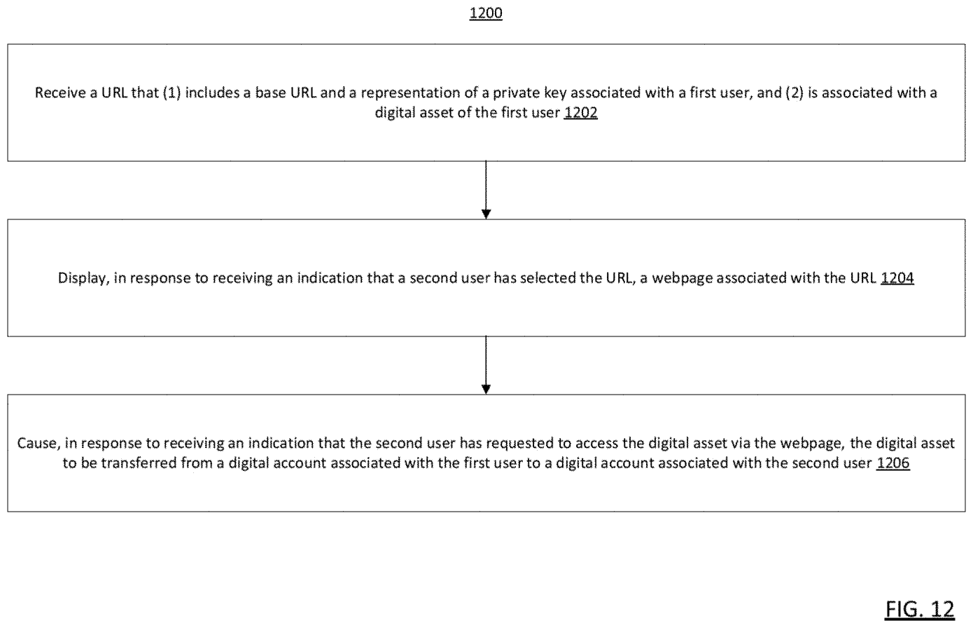

FIG. 12 shows a flowchart of a method 1200 to receive a digital asset via a URL, according to an embodiment. In some implementations, method 1200 can be performed by a processor (e.g., processor 102 and/or 132).

At 1202, a URL (e.g., URL 112) is received that (1) includes a base URL (e.g., base URL 114) and a representation of a private key (e.g., private key 116) associated with a first user (e.g., user U1), and (2) is associated with a digital asset (e.g., digital asset 110) of the first user. In some implementations, the digital asset is a cryptocurrency. In some implementations, a length of the representation of the private key is shorter than a length of the private key. At 1204, a webpage associated with the URL is displayed in response to receiving an indication that a second user (e.g., user U2) has selected the URL. In some implementations, 1204 occurs automatically (e.g., without human intervention) in response to completing 1202. At 1206, the digital asset is caused to be transferred from a digital account (e.g., digital account 108) associated with the first user to a digital account (e.g., digital account 136) associated with the second user in response to receiving an indication that the user has requested to access the digital asset via the webpage.

In some implementations of method 1200, the digital account associated with the first user is a digital asset wallet associated with the first user, the digital account associated with the second user is a digital asset wallet associated with the second user, and method 1200 further includes creating the digital asset wallet associated with the second user prior to causing the digital asset to be transferred from the digital asset wallet associated with the first user to the digital asset wallet associated with the second user.

In some implementations of method 1200, the URL further includes a URL anchor. In some implementations, the URL includes only the base URL, the URL anchor, and the representation of the private key (the representation of the private key being the fragment). In some implementations, a sequence of the URL is the base URL followed by the URL anchor followed by the representation of the private key.

Some implementations of method 1200 further include, in response to receiving the indication that the second user has requested to access the digital asset, (1) receiving an indication from the second user to connect to the digital account associated with the second user at the webpage, and (2) connecting to the digital account associated with the second user. The digital asset is transferred to the digital account associated with the second user in response to connecting to the digital asset associated with the second user.

Some implementations of method 1200 further include, in response to receiving the indication that the second user has requested to access the digital asset, (1) receiving an indication to claim the digital asset to a public key at the webpage, the public key associated with the second user, and (2) receiving an indication of the public key. The digital asset is transferred to the digital account associated with the second user in response to the receiving of the indication of the public key.

Some implementations of method 1200 further include generating the digital account associated with the second user after receiving the URL, after displaying the webpage associated with the URL, and before the digital asset is transferred from the digital account associated with the first user to the digital account associated with the second user.

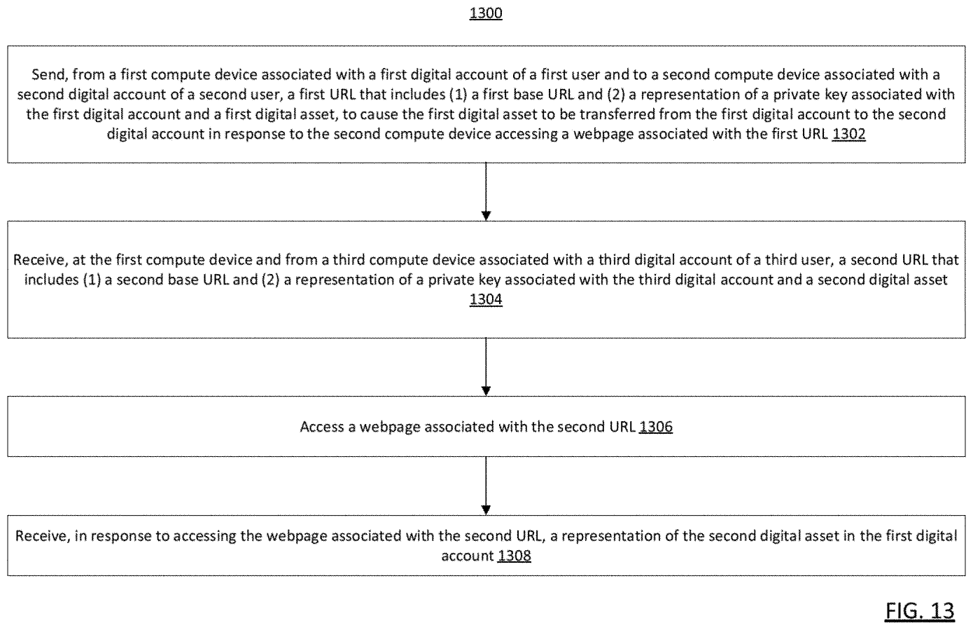

FIG. 13 shows a flowchart of a method 1300 to send and receive digital assets via URLs, according to an embodiment. In some implementations, method 1300 can be performed by a processor (e.g., processor 102 and/or 132).

At 1302, send, from a first compute device (e.g., sending compute device 100) associated with a first digital account (e.g., digital account 108) of a first user (e.g., user U1) and to a second compute device (e.g., receiving compute device 130) associated with a second digital account (e.g., digital account 136) of a second user (e.g., user U2), a first URL (e.g., URL 112) that includes (1) a first base URL (e.g., base URL 114) and (2) a representation of a private key (e.g., private key 116) associated with the first digital account and a first digital asset (e.g., digital asset 110), to cause the first digital asset to be transferred from the first digital account to the second digital account in response to the second compute device accessing a webpage associated with the first URL.

At 1304, receive, at the first compute device and from a third compute device associated with a third digital account of a third user, a second URL that includes (1) a second base URL and (2) a representation of a private key associated with the third digital account and a second digital asset. At 1306, access a webpage associated with the second URL. In some implementations, 1306 occurs automatically (e.g., without human intervention) in response to completing 1304. At 1308, receive, in response to accessing the webpage associated with the second URL, a representation of the second digital asset in the first digital account. In some implementations, 1308 occurs automatically (e.g., without human intervention) in response to completing 1306.

In some implementations, though steps 1304, 1306, and 1308 are performed in sequence, 1302 can occur anytime. For example, 1302 can occur before at least one of 1304, 1306, and 1308, after at least one of 1304, 1306, and 1308, or at the same time as at least one of 1304, 1306, and 1308.

In some implementations of method 1300, the first URL further includes a URL anchor separating the first base URL and the representation of the private key associated with the first digital account and the first digital asset. The second URL further includes a URL anchor separating the second base URL and the representation of the private key associated with the third digital account and the second digital asset.

In some implementations of method 1300, a length of the representation of the private key associated with the first digital account and the first digital asset is shorter than a length of the private key associated with the first digital account and the first digital asset, and a length of the representation of the private key associated with the third digital account and the second digital asset is shorter than a length of the private key associated with the third digital account and the second digital asset.

Some implementations of method 1300 further include transferring, after receiving the representation of the second digital asset in the first digital account, the second digital asset from the first digital account to a fourth digital account of the first user.

In some implementations of method 1300, the first digital asset is a first type of cryptocurrency, and the second digital asset is a second type of cryptocurrency different than the first type of cryptocurrency.

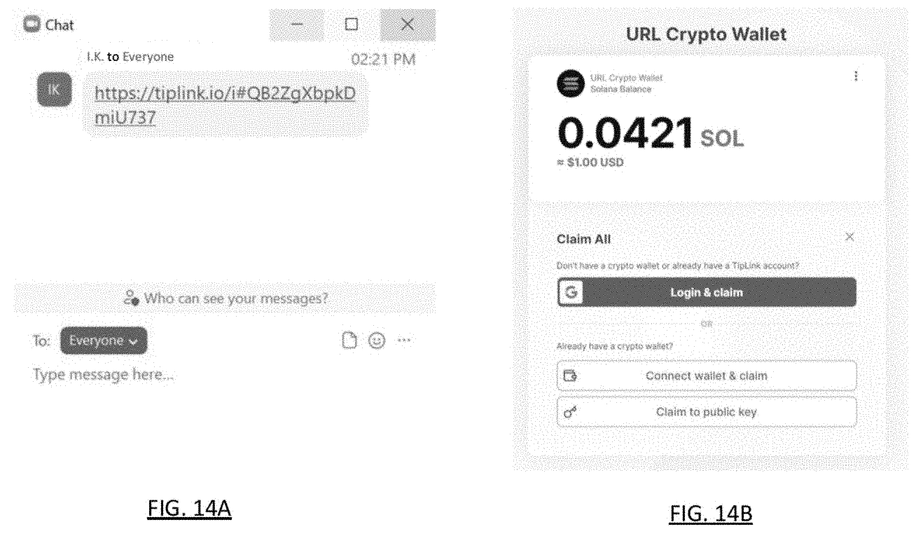

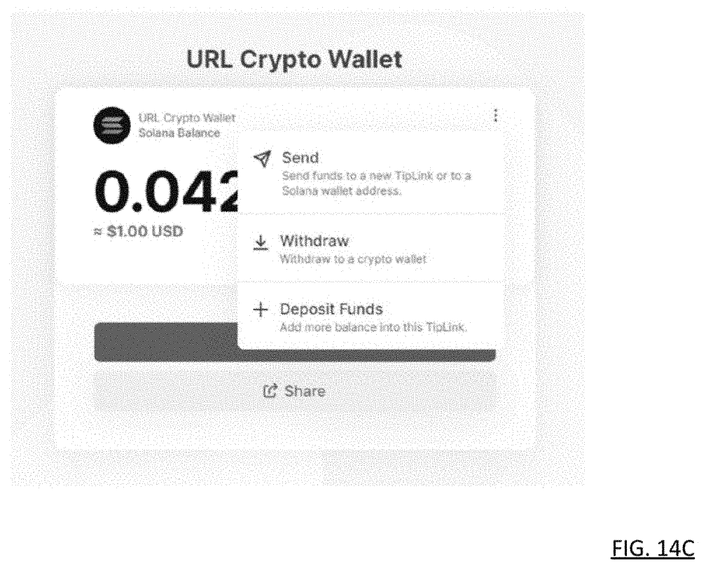

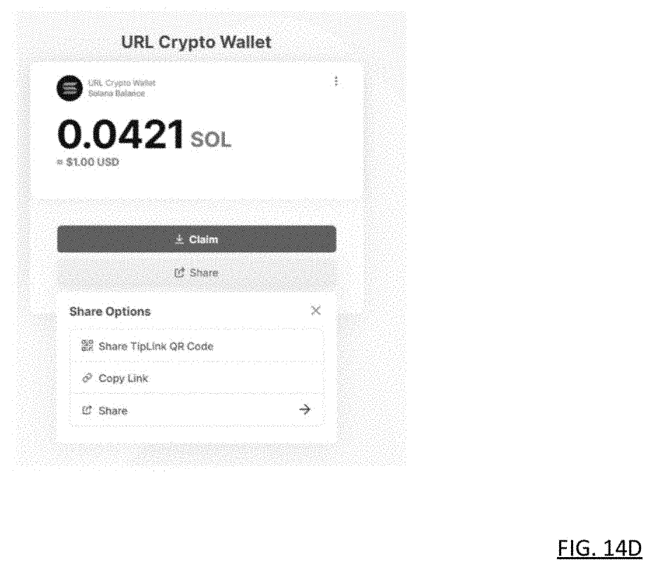

FIGS. 14A-14D shows example screenshots after receiving a URL (e.g., URL 112), according to an embodiment. FIG. 14A shows a chat interface, according to an embodiment. A user (e.g., user U1) associated with a sending compute device (e.g., sending compute device 100), has provided a URL (e.g., URL 112) in the chat: https://tiplink_io/i#QB2ZgXbpkDmiU737. The URL includes a base URL (https://tiplink.io/i), an anchor fragment (#), and a fragment that is a shortened version of a private key (QB2ZgXbpkDmiU737). A user (e.g., user U2) may use a receiving compute device (e.g., receiving compute device 130) to access the URL.

FIG. 14B shows an interface that can be shown at receiving compute device in response to selecting the URL from FIG. 14A, according to an embodiment. As shown, the receiving compute device is able to redeem 0.0421 SOL (i.e., a type of cryptocurrency called Solana), equal to roughly $1.00 at the time the URL was accessed. The user of the receiving compute device has a variety of options to redeem this SOL. For example, if the user doesn't have a crypto wallet, the user can select “Login & claim.” In response, the receiving compute device can show another window that can be used to create a crypto wallet and redeem the SOL. If the user does have a crypto wallet, the user can select “Connect wallet & claim” (to login to a crypto wallet that can hold the crypto, such as a Solana wallet to hold Solana) or “Claim to public key” (to enter a public key identifying a wallet to which the SOL is to be sent).

In some implementations, as shown in FIG. 14C, the user has the option to (1) send the SOL to a someone else (e.g., generate a new URL) or a crypto wallet address, (2) withdraw the SOL to a crypto wallet, and/or (3) add more SOL to the current balance of 0.0421 SOL. In some implementations, as shown in FIG. 14D, the user has the option to share the current balance of SOL via a visual code (e.g. QR code), copy the URL, or share via a third party app (e.g., iMessage, Gmail, etc.).

Combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. As such, all examples and/or embodiments are deemed to be non-limiting throughout this disclosure.

It is to be understood that the logical and/or topological structure of any combination of any program components (a component collection), other components and/or any present feature sets as described in the Figures and/or throughout are not limited to a fixed operating order and/or arrangement, but rather, any disclosed order is an example and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

Embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting.

1. A method, comprising:
receiving, via a processor of a first compute device, a request to send a digital asset associated with a digital account of a user;
generating, via the processor and in response to receiving the request, a URL that includes (1) a base URL and (2) a representation of a private key associated with the digital asset and the digital account of the user; and
causing, via the processor, the URL to be received by a second compute device that is configured to have access to the digital asset in response to accessing the URL.

2. The method of claim 1, wherein:
the URL further includes a URL anchor,
the URL including only the base URL, the URL anchor, and the representation of the private key,
a sequence of the URL being the base URL followed by the URL anchor followed by the representation of the private key.

3. The method of claim 1, wherein a length of the representation of the private key is shorter than a length of the private key, the method further comprising:
generating the representation of the private key using the private key and a key derivation function.

4. The method of claim 3, wherein the key derivation function is at least one of compute intensive or memory intensive.

5. The method of claim 1, wherein the request does not indicate a recipient of the digital asset.

6. The method of claim 1, wherein the digital asset is a cryptocurrency, the digital account of the user is a digital asset wallet, and the request indicates an amount of cryptocurrency requested to be sent.

7. The method of claim 1, wherein the request is a first request, the digital asset is a first digital asset, the URL is a first URL, and the method further comprises:
receiving a second request to send a second digital asset;
generating a second URL that includes the base URL and the representation of the private key; and
causing the second URL to be received by a third compute device different than the second compute device, the third compute device configured to have access to the second digital asset in response to accessing the second URL, the second compute device not configured to have access to the second digital asset in response to accessing the first URL.

8. The method of claim 1, further comprising
generating, via the processor and in response to receiving the request, a visual code associated with the URL,
the second compute device configured to have access to the digital asset by accessing the URL via the visual code.

9-21. (canceled)

22. The method of claim 1, wherein the first compute device is a smartphone.

23. The method of claim 1, wherein the digital account of the user includes (1) a seed phrase and (2) the private key associated with the digital asset and the digital account of the user.

24. The method of claim 1, wherein the second compute device receives the URL via at least one of an email, a text message, a direct message, or a chat message.

25. The method of claim 1, wherein the user is a first user, the second compute device is associated with a second user, and the second compute device is configured to have access to the digital asset in response to accessing the URL by:
displaying a webpage associated with the URL in response to receiving the URL; and
causing, in response to receiving an indication that the second user has requested to access the digital asset via the webpage, the digital asset to be transferred from the digital account of the first user to a digital account of the second user.

26. The method of claim 25, wherein the digital account of the first user is a digital asset wallet associated with the first user, the digital account of the second user is a digital asset wallet associated with the second user, and the second compute device is further configured to:
create the digital asset wallet associated with the second user prior to the causing the digital asset to be transferred from the digital asset wallet associated with the first user to the digital asset wallet associated with the second user.

27. The method of claim 25, wherein the second compute device is further configured to, in response to receiving the indication that the second user has requested to access the digital asset:
receive from the second user an indication to connect to the digital account of the second user at the webpage; and
connect to the digital account of the second user, the digital asset transferred to the digital account of the second user in response to the connecting to the digital account of the second user.

28. The method of claim 25, wherein the second compute device is further configured to, in response to receiving the indication that the second user has requested to access the digital asset:
receive an indication to claim the digital asset to a public key at the webpage, the public key associated with the second user; and
receive an indication of the public key, the digital asset transferred to the digital account of the second user in response to the receiving of the indication of the public key.

29. The method of claim 25, wherein the second compute device is further configured to:
generate the digital account of the second user after receiving the URL, after displaying the webpage associated with the URL, and before the digital asset is transferred from the digital account of the first user to the digital account of the second user.

30. The method of claim 1, wherein the URL is a first URL, the base URL is a first base URL, the digital account of the user is a first digital account of a first user, and the digital asset is a first digital asset, the method further comprising:
receiving, at the first compute device and from a third compute device associated with a second digital account of a second user, a second URL that includes (1) a second base URL and (2) a representation of a private key associated with the second digital account and a second digital asset;
accessing a webpage associated with the second URL; and
receiving, in response to the accessing the webpage associated with the second URL, a representation of the second digital asset in the first digital account of the first user.

31. The method of claim 30, wherein the second URL further includes a URL anchor separating the second base URL and the representation of the private key associated with the second digital account and the second digital asset.

32. The method of claim 30, wherein a length of the representation of the private key associated with the second digital account and the second digital asset is shorter than a length of the private key associated with the second digital account and the second digital asset.

33. The method of claim 30, wherein the first digital asset is a first type of cryptocurrency, and the second digital asset is a second type of cryptocurrency different than the first type of cryptocurrency.

34. The method of claim 30, further comprising:
receiving, at the first compute device and from a fourth compute device associated with a third digital account of a third user, a third URL that includes (1) a third base URL and (2) a representation of a private key associated with the third digital account and a third digital asset;
accessing a webpage associated with the third URL; and
receiving, in response to the accessing the webpage associated with the third URL, a representation of the third digital asset in the first digital account of the first user.
